(19) United States
(12) Patent Application Publication
(10) Pub. No.: US 2024/0167491 A1
(43) Pub. Date: May 23, 2024

(54) NOVEL INTERNAL PRESSURE MONITORING SYSTEM FOR PIPES

(71) Applicant: Angelo Seminara, Guelph (CA)

(72) Inventor: Angelo Seminara, Guelph (CA)

(21) Appl. No.: 17/990,970

(22) Filed: Nov. 21, 2022

(51) Int. Cl. F15C 1/00; E03B 7/07; G01L 19/08; G01L 19/12

(52) U.S. Cl. CPC F15C 1/005; E03B 7/07; G01L 19/086; G01L 19/12; E03C 1/02

(57) ABSTRACT

The present invention is a for monitoring and alerting an operator to internal piping air pressure variations whereby said system includes an air pressure gauge and a smart screen, whereby said smart screen is constructed with communications capability to alert a system operator in real time when a pressure threshold has been breached.

### BACKGROUND OF THE INVENTION

As persons in the building, plumbing, and pipefitting industry are aware, it is often extremely important that the systems be constructed, installed, and maintained, such that there is no change in the internal pressure. Systems of this type include not only plumbing for the transportation of water, but there are significant systems we are by gases are transported in numerous environments. All the reference will be made herein to water and plumbing transport systems, the present invention contemplates utilization with any type of liquid gas piping distribution system.

Often, when the desired pressure of a drain/vent system or a water piping distribution system has been achieved, the pipes/fittings can be covered up by usually means of drywall.

It is unfortunately a common occurrence that while the construction of the project resumes and other trades people perform their work/tasks, often times there is accidental puncturing of the plumbing pipes/fittings. Without the system being under constant pressure, the puncture (typically a screw hole or a saw cut) is not found until weeks later when the plumbing contractor is ready to introduce water to the plumbing system. At this point, there is a situation where water damage will occur, but the upside of this puncture is that the leak can usually be easily located due to the water damage.

In worst case, the puncture is located in the venting portion of the plumbing system and is very difficult to locate, in some cases nearly impossible. In most “new construction” projects a “smoke test” is required to be performed successfully and witnessed by the local inspector. This is required to ensure that the home/project is delivered to the customer with no leaks in the drainage/venting portion of the plumbing system and to ensure that harmful gases are not entering the dwelling via a puncture or opening of any sort.

There is a need for a real time monitoring system that provides remote data whereby an operator can be informed when a variation in pressure has been detected.

The present invention addresses this need.

### SUMMARY OF THE INVENTION

In the system of the present invention, a puncture is identified immediately in “real time” and allow for the problem to be addressed and corrected before it became a more difficult and daunting task for the plumber to locate the puncture in a fully and completely finished dwelling.

In one embodiment, the system will send an alert alarm to a remote operator indicating a variation in test pressure. By sending a real time alarm, a system operator can immediately contact a person physically on location in order to address the pressure variation.

Remote Air Pressure Monitoring System,

The present invention includes a “smart digital air pressure gauge”, herein, simply referred to as a smart screen, that when installed/connected to mainly ‘new construction’ pluming systems would have the capability of sending a mobile alert to an individual when the achieved air pressure (for testing purposes) has been compromised systems.

It is contemplated that in providing the real time alerts according to the system at present invention, the location of a breach can quickly be ascertained based on work being currently performed near a system that is being monitored.

With the system and “smart screen” of the present invention, all the testing equipment/devices are left installed with a pressure test holding insuring that as the project progresses the system is monitored!

The system is installed and in any vent stacks, plumbing drains, and sewers are all sealed off. The system is then introduced air through the “smart screen” by means of any generic compressor/air pump pressurized to a standing pressure of 5 psi. This test is performed to ensure that there are no “leaks” in the system.

Should the pressure descend in the following hours, days or even weeks from the desired pressure, in this case 5 psi (Water distribution piping would be tested in the same manner but to a desired pressure of 100 psi) an alert to a smart phone would be received to notify in real time to any individual that has purchased the App that the system has dropped in pressure and needs immediate attention.

In one embodiment, the present invention is A system for monitoring internal pressure of liquid or gas distribution piping, said system comprising:
an inlet valve;
an air pump having an air distribution hose associated therewith, said air distribution hose connected to said inlet valve;
a pressure gauge configured for measuring internal air pressure in said distribution piping;
a smart screen, said smart screen configured to monitoring real time air pressure measurements, recording and logging historical air pressure measurement data, and communicating said real time and historical air pressure measurement data to a receiver, said receiver is one or more of a smart screen located with said system for monitoring internal pressure, a cell phone, or a microprocessor based receiver at a monitoring station, said smart screen having user configurable thresholds for initiating an alert in response to said pressure gauge detecting pressure beyond the threshold limit

In one embodiment, the pressure gauge is directly connected to said smart screen.

In one embodiment, the pressure gauge is wirelessly connected to said smart screen.

In one embodiment, the smart screen is wirelessly connected to one or more of a smart screen located with said system, a cell phone, or a microprocessor-based receiver at a monitoring station.

In one embodiment, the smart screen is wirelessly connected to one or more cell phones.

In one embodiment, the smart screen is wirelessly connected to one or more cell phones and sends an audio alert, a visual alert, or an audio-visual alert.

In one embodiment, the smart screen sends an email alert, an SMS/test alert, or each of email and SMS text alerts.

In one embodiment, the smart screen receives, logs, and compiles historical air pressure readings over time.

In one embodiment, the smart screen is configured with anti-theft components including a security chip that deactivates said smart screen when removed from said system.

In one embodiment, the smart screen is configured with anti-theft components including a security chip that deactivates said smart screen when removed from said system and GPS location chip that monitors real-time physical location and transmits real time location information to any one or combination of said smart screen located with said system, a cell phone, or a microprocessor-based receiver at a monitoring station.

### BRIEF DESCRIPTION OF THE SEVERAL VIEWS OF THE DRAWINGS

FIG. 1 is a schematic view of the system according to one embodiment of the present invention.

FIG. 2 is a smart screen according to one embodiment of the present invention.

FIG. 3 is a smart screen according to one embodiment of the present invention.

FIG. 4 is a smart screen according to one embodiment of the present invention.

FIG. 5 is a smart screen according to one embodiment of the present invention.

FIG. 6 is a smart screen according to one embodiment of the present invention.

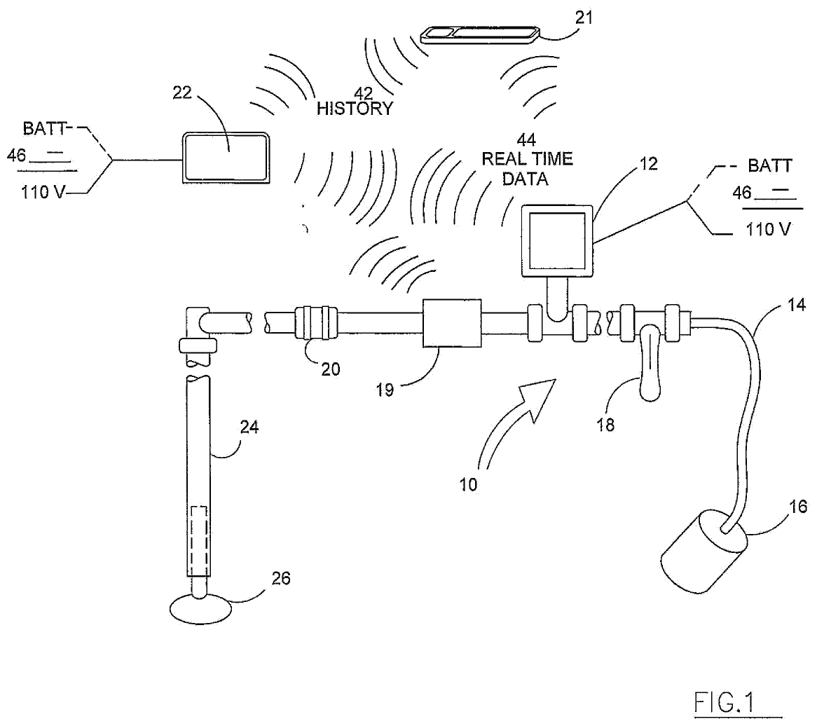

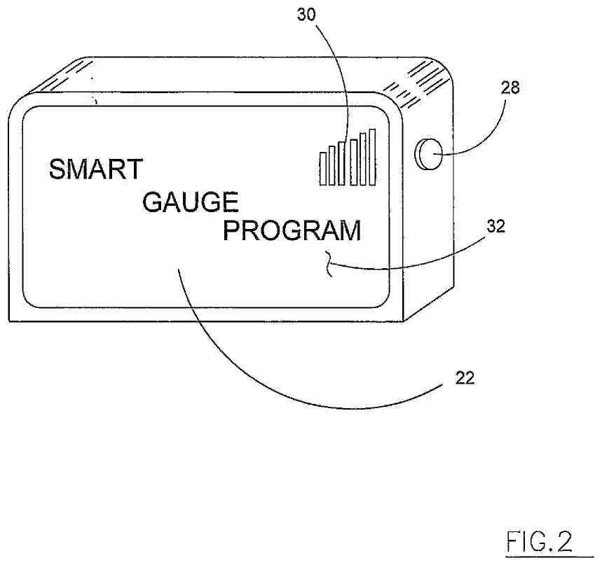

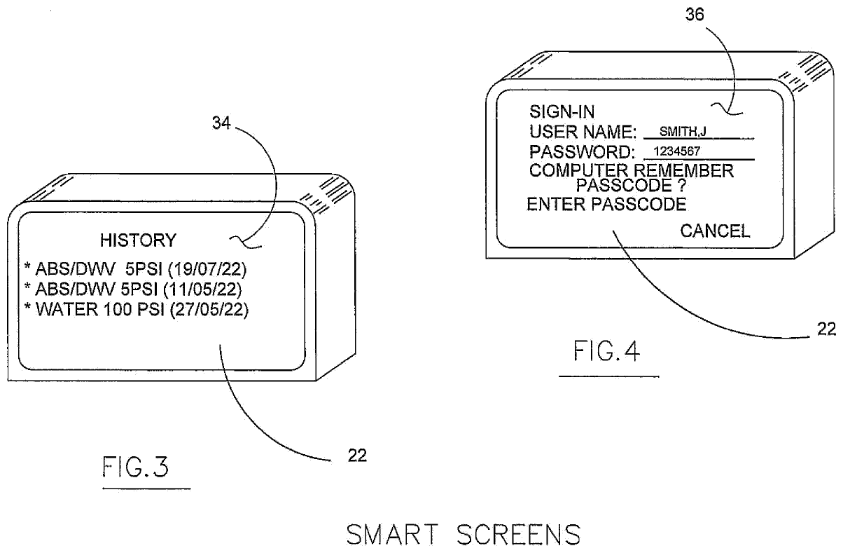

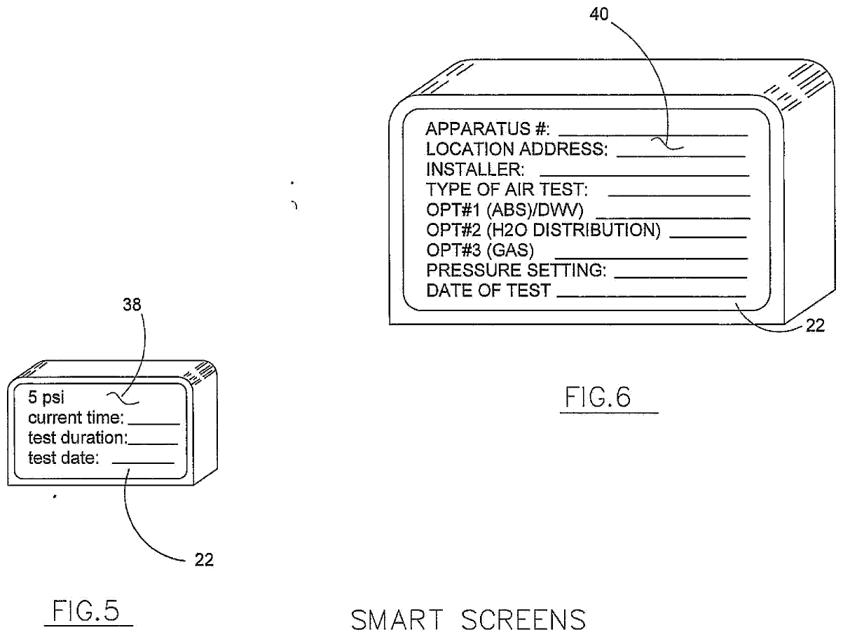

### DETAILED DESCRIPTION OF THE PREFERRED EMBODIMENTS

Although the drawings depict a particularized embodiment, the present invention is contemplated as configurable in any physical structure whereby the inventive scope and concept are achieved.

As generally understood, system 10 is an air pressure leak identification system particularly useful for detecting leaks in air and liquid distribution systems.

Microprocessor based system smart screen 12 has battery 46 and wireless data communication 44 that transmits two either one or both of a microprocessor based smart screen 22 or cell phone 21. Sensor gauge 19 is attached in-line to system 10 and provides monitoring of real time internal pressure data. Air pump 16 is connected to air feed tube 14 and shut off valve 18. Flexible connection couple and 20 provides connection to a test pipe 24 that is further connected to a test plug 26. As generally understood, test plug 26 is security position, system tennis pressurized, and gage 19 monitors internal pressure. In one embodiment, smart screen 12 has a video output 32 and an actuator 28 whereby display 32 provides information about current and historical pressure readings provided from pressure gauge 19. In one embodiment, a second screen 36 provides encryption such that information about pressure on system 10 is only viewable by authenticated users. This is demonstrated in security sign in screen 36 in display 38, current real-time internal pressure information from system 10 is provided to smart screen 12. Additionally, historical pressure information is provided on display 40.

In one embodiment, sensor gauge 19 is constructed and arranged with security features such that if sensor gauge 19 is removed, it is inoperable unless receiving an authorization signal from smart screen 12.

The system of the present invention is installed in either new construction or repair of existing piping systems. Air pressure as per local building code is introduced into the sealed system. As noted above, the introduced air pressure will be different depending on the installation and use of the system. A system used to transport medical gas such as helium, oxygen, and other such medical gases, will be pressurized to a higher test pressure. Plumbing and piping systems that are constructed for the transport water, are typically pressurized at lower pressures, e.g., 5 psi.

The smart screen 12 is configured for monitoring at a set pressure overtime. There is a threshold by which the smart screen actuates an alert. If pressure drops below the threshold, smart screen 12 transmit an alert in real time data 44 that is received by either or both of a smart screen 22 or a cell phone 21. When an alert is transmitted to cell phone 21, the alert can include any one or combination of current pressure measurement, location of the positioned system, historical pressure readings, and the like. The alert includes any one or more of, an email, a text alert, and audio alarm, and a visual alarm. As discussed above, it is contemplated that smart screen 12 and sensor gauge 19 are constructed with security features such that if one were to remove one of the components, the removed component is rendered in operable. Another embodiment, smart screen 12 is constructed with GPS location capability whereby if smart screen 12 is removed from an assigned site, smart screen 12 becomes in operable, and sends a wireless signal to either or both of smart screen 22 and cell phone 21 alerting that smart screen 12 is no longer located as placed and transmitting real time location information of smart screen 12.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed:

1. A system for monitoring internal pressure of liquid or gas distribution piping, said system comprising:
an inlet valve;
an air pump having an air distribution hose associated therewith, said air distribution hose connected to said inlet valve;
a pressure gauge configured for measuring internal air pressure in said distribution piping;
a smart screen, said smart screen configured to monitoring real time air pressure measurements, recording and logging historical air pressure measurement data, and communicating said real time and historical air pressure measurement data to a receiver, said receiver is one or more of a smart screen located with said system for monitoring internal pressure, a cell phone, or a microprocessor based receiver at a monitoring station, said smart screen having user configurable thresholds for initiating an alert in response to said pressure gauge detecting pressure beyond the threshold limit.

2. The system of claim 1, wherein said pressure gauge is directly connected to said smart screen.

3. The system of claim 1, wherein said pressure gauge is wirelessly connected to said smart screen.

4. The system of claim 1, wherein said smart screen is wirelessly connected to one or more of a smart screen located with said system, a cell phone, or a microprocessor-based receiver at a monitoring station.

5. The system of claim 1, wherein said smart screen is wirelessly connected to one or more cell phones.

6. The system of claim 1, wherein said smart screen is wirelessly connected to one or more cell phones and sends an audio alert, a visual alert, or an audio-visual alert.

7. The system of claim 1, wherein said smart screen sends an email alert, an SMS/test alert, or each of email and SMS text alerts.

8. The system of claim 1, wherein said smart screen receives, logs, and compiles historical air pressure readings over time.

9. The system of claim 1, wherein said smart screen is configured with anti-theft components including a security chip that deactivates said smart screen when removed from said system.

10. The system of claim 1, wherein said smart screen is configured with anti-theft components including a security chip that deactivates said smart screen when removed from said system and GPS location chip that monitors real-time physical location and transmits real time location information to any one or combination of said smart screen located with said system, a cell phone, or a microprocessor-based receiver at a monitoring station.
